(19) United States
(12) Patent Application Publication
(10) Pub. No.: US 2025/0265211 A1
(43) Pub. Date: Aug. 21, 2025

(54) Automatic Port Assignment For Patch Panels

(71) Applicant: Oracle International Corporation, Redwood Shores, CA (US)

(72) Inventors: Krishna Chaitanya Sunkara, Morrisville, NC (US); Akshay Mahesh Bhusare, Austin, TX (US)

(73) Assignee: Oracle International Corporation, Redwood Shores, CA (US)

(21) Appl. No.: 18/613,383

(22) Filed: Mar. 22, 2024

Related U.S. Application Data
(60) Provisional application No. 63/556,055, filed on Feb. 21, 2024.

(51) Int. Cl. G06F 13/40

(52) U.S. Cl. CPC G06F 13/4068

(57) ABSTRACT

Techniques for automatic assignment of patch panel ports are disclosed. The system accesses a first set of information identifying a plurality of source patch panel ports and a second set of information identifying a plurality of destination patch panel ports. The system accesses, based on the first set of information, a first directed acyclic graph representing a first source patch panel. Additionally, the system accesses, based on the second set of information, a second directed acyclic graph representing a first destination patch panel. The system selects a port assignment strategy from a plurality of port assignment strategies for mapping the plurality of source ports to the plurality of destination ports. The system traverses the first directed acyclic graph and the second directed acyclic graph in accordance with the selected port assignment strategy to generate a mapping of the plurality of source port nodes to the plurality of destination port nodes.

### INCORPORATION BY REFERENCE; DISCLAIMER

Each of the following applications are hereby incorporated by reference: Application No. 63/556,055, filed Feb. 21, 2024. The applicant hereby rescinds any disclaimer of claims scope in the parent application(s) or the prosecution history thereof and advises the USPTO that the claims in the application may be broader than any claim in the parent application(s).

### TECHNICAL FIELD

The present disclosure relates to data center engineering. In particular, the present disclosure relates to automated assignment of ports in one or more source patch panels to ports in one or more destination patch panels in a data center.

### BACKGROUND

Data centers typically include large numbers of server racks, e.g., hundreds or thousands. Racks can include patch panels that contain ports. Racks can be interconnected through these patch panel ports using cables, e.g., fiber cables. The act of interconnecting the racks may occur, for example, during expansion of a data center or when setting up a new data center. Prior to physically interconnecting the racks, ports in a source patch panel need to be assigned to ports in a destination patch panel. Such assignment can be challenging because of the various considerations that need to be taken into account. As an example, there may be different assignment patterns; source to destination connections may be 1 to 1, or 1 to many, or many to 1, or many to many. As another example, the port assignment on either a source or destination may start at any position within a panel. As another example, a source and a destination may have any number of paths within. As another example, the number of ports to be connected at a time varies and is dependent on the cable used. As another example, a source and a destination sometimes cannot be connected directly; rather there may be a bridge panel in between, which may be termed as a “next hop.” As another example, there may be a limitation as to the number of ports on a given panel that can be mapped even when there are available (empty) ports available. As another example, the starting position of a panel and the navigation across the panel varies based on the panel type.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. References to “an” or “one” embodiment in this disclosure are not necessarily to the same embodiment, and they mean at least one. In the drawings:

FIGS. 1-4 are block diagrams illustrating patterns for implementing a cloud infrastructure as a service system in accordance with one or more embodiments;

FIG. 5 is a hardware system in accordance with one or more embodiments;

FIG. 6 illustrates a system in accordance with one or more embodiments;

FIG. 7 illustrates an example set of operations for automatically assigning source patch panel ports to destination patch panel ports in accordance with one or more embodiments;

FIG. 8 illustrates an example of a directed acyclic graph in accordance with one or more embodiments; and

FIG. 9 illustrates a machine learning process according to one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. CLOUD COMPUTING TECHNOLOGY
3. COMPUTER SYSTEM
4. AUTOMATIC PORT ASSIGNMENT ARCHITECTURE
5. ASSIGNING PORTS AUTOMATICALLY
6. EXAMPLE EMBODIMENT
7. MACHINE LEARNING
8. PRACTICAL APPLICATIONS, ADVANTAGES, AND IMPROVEMENTS
9. MISCELLANEOUS; EXTENSIONS

1. General Overview

Data center server racks can include one or more patch panels that allow racks to be interconnected. A patch panel has multiple, numbered ports that are termination points for cables, e.g., fiber optic cables. Connecting a source patch panel to a destination patch panel requires an assignment mapping of a source patch panel port to a destination patch panel port, so errors and port collisions can be avoided.

One or more embodiments represent a patch panel as a directed acyclic graph that is agnostic to the type of patch panel represented and does not need a defined navigation pattern. The system may traverse a source directed acyclic graph sequentially and assign destination ports to source ports according to a port assignment strategy. The system may populate a spreadsheet representation of the source patch panel and destination patch panel with port identifiers and use color coding or other visual aid for use as a reference by a human engineer in making the physical connections.

The system may select a port assignment strategy based on factors such characteristics of the patch panels being connected, or the data center layout. Additional factors may include whether or not the patch panels already have some ports assigned. The system may train and apply a machine learning (ML) model to select a port assignment strategy. The ML model may be applied to patch panel definitions, a rack mapping that includes sets of unassigned source and destination ports in the patch panels, and data center layout information to select a port assignment strategy.

In an example, the system accesses information identifying a plurality of source ports in one or more source patch panels and information identifying a plurality of destination ports in one or more destination patch panels. Based on the information, the system accesses a source directed acyclic graph representing a first source patch panel and a destination directed acyclic graph representing a first destination patch panel. The source directed acyclic graph includes source port nodes corresponding respectively to the source ports in the first source patch panel. The destination directed acyclic graph includes destination port nodes corresponding respectively to the destination ports in the destination patch panel. The system selects a port assignment strategy from a plurality of port assignment strategies for mapping the plurality of source ports to the plurality of destination ports. The system traverses the source directed acyclic graph and the destination directed acyclic graph in accordance with the selected port assignment strategy to generate a mapping of the source port nodes to the destination port nodes.

One or more embodiments described in this Specification and/or recited in the claims may not be included in this General Overview section.

2. CLOUD COMPUTING TECHNOLOGY

Infrastructure as a Service (IaaS) is an application of cloud computing technology. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components; example services include billing software, monitoring software, logging software, load balancing software, clustering software, etc. Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on the VMs, deploy middleware such as databases, create storage buckets for workloads and backups, and install enterprise software into that VM. Customers can then use the provider's services to perform various functions, including balancing network traffic, troubleshooting application issues, monitoring performance, and managing disaster recovery, etc.

In some cases, a cloud computing model will involve the participation of a cloud provider. The cloud provider may, but need not, be a third-party service that specializes in providing (e.g., offering, renting, selling) IaaS. An entity may also opt to deploy a private cloud, becoming its own provider of infrastructure services.

In some examples, IaaS deployment is the process of implementing a new application, or a new version of an application, onto a prepared application server or other similar device. IaaS deployment may also include the process of preparing the server (e.g., installing libraries, daemons, etc.). The deployment process is often managed by the cloud provider below the hypervisor layer (e.g., the servers, storage, network hardware, and virtualization). Thus, the customer may be responsible for handling (OS), middleware, and/or application deployment, such as on self-service virtual machines. The self-service virtual machines can be spun up on demand.

In some examples, IaaS provisioning may refer to acquiring computers or virtual hosts for use, even installing needed libraries or services on them. In most cases, deployment does not include provisioning, and the provisioning may need to be performed first.

In some cases, there are challenges for IaaS provisioning. There is an initial challenge of provisioning the initial set of infrastructure. There is an additional challenge of evolving the existing infrastructure (e.g., adding new services, changing services, removing services, etc.) after the initial provisioning is completed. In some cases, these challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on one another, and how they work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up for one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). In some embodiments, infrastructure and resources may be provisioned (manually, and/or using a provisioning tool) prior to deployment of code to be executed on the infrastructure. However, in some examples, the infrastructure that will deploy the code may first be set up. In some instances, the provisioning can be done manually, a provisioning tool may be utilized to provision the resources, and/or deployment tools may be utilized to deploy the code once the infrastructure is provisioned.

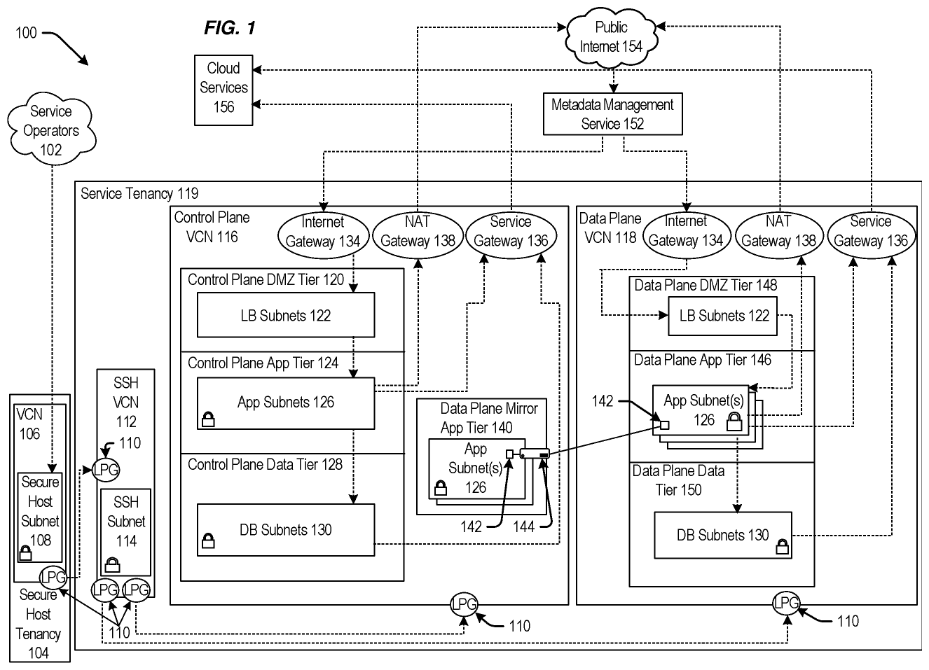

FIG. 1 is a block diagram illustrating an example pattern of an IaaS architecture 100 according to at least one embodiment. Service operators 102 can be communicatively coupled to a secure host tenancy 104 that can include a virtual cloud network (VCN) 106 and a secure host subnet 108. In some examples, the service operators 102 may be using one or more client computing devices, such as portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers, including personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems such as Google Chrome OS. Additionally, or alternatively, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 106 and/or the Internet.

The VCN 106 can include a local peering gateway (LPG) 110 that can be communicatively coupled to a secure shell (SSH) VCN 112 via an LPG 110 contained in the SSH VCN 112. The SSH VCN 112 can include an SSH subnet 114, and the SSH VCN 112 can be communicatively coupled to a control plane VCN 116 via the LPG 110 contained in the control plane VCN 116. Also, the SSH VCN 112 can be communicatively coupled to a data plane VCN 118 via an LPG 110. The control plane VCN 116 and the data plane VCN 118 can be contained in a service tenancy 119 that can be owned and/or operated by the IaaS provider.

The control plane VCN 116 can include a control plane demilitarized zone (DMZ) tier 120 that acts as a perimeter network (e.g., portions of a corporate network between the corporate intranet and external networks). The DMZ-based servers may have restricted responsibilities and help keep breaches contained. Additionally, the DMZ tier 120 can include one or more load balancer (LB) subnet(s) 122, a control plane app tier 124 that can include app subnet(s) 126, a control plane data tier 128 that can include database (DB) subnet(s) 130 (e.g., frontend DB subnet(s) and/or backend DB subnet(s)). The LB subnet(s) 122 contained in the control plane DMZ tier 120 can be communicatively coupled to the app subnet(s) 126 contained in the control plane app tier 124 and an Internet gateway 134 that can be contained in the control plane VCN 116. The app subnet(s) 126 can be communicatively coupled to the DB subnet(s) 130 contained in the control plane data tier 128 and a service gateway 136 and a network address translation (NAT) gateway 138. The control plane VCN 116 can include the service gateway 136 and the NAT gateway 138.

The control plane VCN 116 can include a data plane mirror app tier 140 that can include app subnet(s) 126. The app subnet(s) 126 contained in the data plane mirror app tier 140 can include a virtual network interface controller (VNIC) 142 that can execute a compute instance 144. The compute instance 144 can communicatively couple the app subnet(s) 126 of the data plane mirror app tier 140 to app subnet(s) 126 that can be contained in a data plane app tier 146.

The data plane VCN 118 can include the data plane app tier 146, a data plane DMZ tier 148, and a data plane data tier 150. The data plane DMZ tier 148 can include LB subnet(s) 122 that can be communicatively coupled to the app subnet(s) 126 of the data plane app tier 146 and the Internet gateway 134 of the data plane VCN 118. The app subnet(s) 126 can be communicatively coupled to the service gateway 136 of the data plane VCN 118 and the NAT gateway 138 of the data plane VCN 118. The data plane data tier 150 can also include the DB subnet(s) 130 that can be communicatively coupled to the app subnet(s) 126 of the data plane app tier 146.

The Internet gateway 134 of the control plane VCN 116 and of the data plane VCN 118 can be communicatively coupled to a metadata management service 152 that can be communicatively coupled to public Internet 154. Public Internet 154 can be communicatively coupled to the NAT gateway 138 of the control plane VCN 116 and of the data plane VCN 118. The service gateway 136 of the control plane VCN 116 and of the data plane VCN 118 can be communicatively couple to cloud services 156.

In some examples, the service gateway 136 of the control plane VCN 116 or of the data plane VCN 118 can make application programming interface (API) calls to cloud services 156 without going through public Internet 154. The API calls to cloud services 156 from the service gateway 136 can be one-way; the service gateway 136 can make API calls to cloud services 156, and cloud services 156 can send requested data to the service gateway 136. However, cloud services 156 may not initiate API calls to the service gateway 136.

In some examples, the secure host tenancy 104 can be directly connected to the service tenancy 119. The service tenancy 119 may otherwise be isolated. The secure host subnet 108 can communicate with the SSH subnet 114 through an LPG 110 that may enable two-way communication over an otherwise isolated system. Connecting the secure host subnet 108 to the SSH subnet 114 may give the secure host subnet 108 access to other entities within the service tenancy 119.

The control plane VCN 116 may allow users of the service tenancy 119 to set up or otherwise provision desired resources. Desired resources provisioned in the control plane VCN 116 may be deployed or otherwise used in the data plane VCN 118. In some examples, the control plane VCN 116 can be isolated from the data plane VCN 118, and the data plane mirror app tier 140 of the control plane VCN 116 can communicate with the data plane app tier 146 of the data plane VCN 118 via VNICs 142 that can be contained in the data plane mirror app tier 140 and the data plane app tier 146.

In some examples, users of the system, or customers, can make requests, for example create, read, update, or delete (CRUD) operations, through public Internet 154 that can communicate the requests to the metadata management service 152. The metadata management service 152 can communicate the request to the control plane VCN 116 through the Internet gateway 134. The request can be received by the LB subnet(s) 122 contained in the control plane DMZ tier 120. The LB subnet(s) 122 may determine that the request is valid, and in response, the LB subnet(s) 122 can transmit the request to app subnet(s) 126 contained in the control plane app tier 124. If the request is validated and requires a call to public Internet 154, the call to public

Internet 154 may be transmitted to the NAT gateway 138 that can make the call to public Internet 154. Metadata that may be desired to be stored by the request can be stored in the DB subnet(s) 130.

In some examples, the data plane mirror app tier 140 can facilitate direct communication between the control plane VCN 116 and the data plane VCN 118. For example, changes, updates, or other suitable modifications to configuration may be desired to be applied to the resources contained in the data plane VCN 118. Via a VNIC 142, the control plane VCN 116 can directly communicate with, and can thereby execute the changes, updates, or other suitable modifications to configuration to, resources contained in the data plane VCN 118.

In some embodiments, the control plane VCN 116 and the data plane VCN 118 can be contained in the service tenancy 119. In this case, the user, or the customer, of the system may not own or operate either the control plane VCN 116 or the data plane VCN 118. Instead, the IaaS provider may own or operate the control plane VCN 116 and the data plane VCN 118. The control plane VCN 116 and the data plane VCN 118 may be contained in the service tenancy 119. This embodiment can enable isolation of networks that may prevent users or customers from interacting with other users′, or other customers′, resources. Also, this embodiment may allow users or customers of the system to store databases privately without needing to rely on public Internet 154 for storage.

In other embodiments, the LB subnet(s) 122 contained in the control plane VCN 116 can be configured to receive a signal from the service gateway 136. In this embodiment, the control plane VCN 116 and the data plane VCN 118 may be configured to be called by a customer of the IaaS provider without calling public Internet 154. Customers of the IaaS provider may desire this embodiment since database(s) that the customers use may be controlled by the IaaS provider and may be stored on the service tenancy 119. The service tenancy 119 may be isolated from public Internet 154.

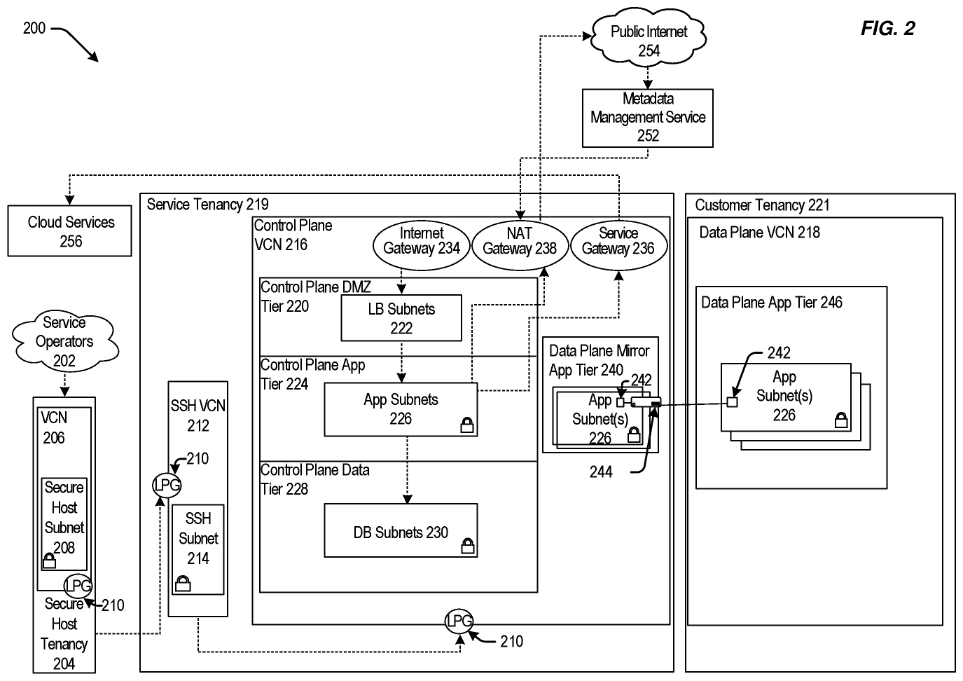

FIG. 2 is a block diagram illustrating another example pattern of an IaaS architecture 200 according to at least one embodiment. Service operators 202 (e.g., service operators 102 of FIG. 1) can be communicatively coupled to a secure host tenancy 204 (e.g., the secure host tenancy 104 of FIG. 1) that can include a virtual cloud network (VCN) 206 (e.g., the VCN 106 of FIG. 1) and a secure host subnet 208 (e.g., the secure host subnet 108 of FIG. 1). The VCN 206 can include a local peering gateway (LPG) 210 (e.g., the LPG 110 of FIG. 1) that can be communicatively coupled to a secure shell (SSH) VCN 212 (e.g., the SSH VCN 112 of FIG. 1) via an LPG 110 contained in the SSH VCN 212. The SSH VCN 212 can include an SSH subnet 214 (e.g., the SSH subnet 114 of FIG. 1), and the SSH VCN 212 can be communicatively coupled to a control plane VCN 216 (e.g., the control plane VCN 116 of FIG. 1) via an LPG 210 contained in the control plane VCN 216. The control plane VCN 216 can be contained in a service tenancy 219 (e.g., the service tenancy 119 of FIG. 1), and the data plane VCN 218 (e.g., the data plane VCN 118 of FIG. 1) can be contained in a customer tenancy 221 that may be owned or operated by users, or customers, of the system.

The control plane VCN 216 can include a control plane DMZ tier 220 (e.g., the control plane DMZ tier 120 of FIG. 1) that can include LB subnet(s) 222 (e.g., LB subnet(s) 122 of FIG. 1), a control plane app tier 224 (e.g., the control plane app tier 124 of FIG. 1) that can include app subnet(s) 226 (e.g., app subnet(s) 126 of FIG. 1), and a control plane data tier 228 (e.g., the control plane data tier 128 of FIG. 1) that can include database (DB) subnet(s) 230 (e.g., similar to DB subnet(s) 130 of FIG. 1). The LB subnet(s) 222 contained in the control plane DMZ tier 220 can be communicatively coupled to the app subnet(s) 226 contained in the control plane app tier 224 and an Internet gateway 234 (e.g., the Internet gateway 134 of FIG. 1) that can be contained in the control plane VCN 216. The app subnet(s) 226 can be communicatively coupled to the DB subnet(s) 230 contained in the control plane data tier 228 and a service gateway 236 (e.g., the service gateway 136 of FIG. 1) and a network address translation (NAT) gateway 238 (e.g., the NAT gateway 138 of FIG. 1). The control plane VCN 216 can include the service gateway 236 and the NAT gateway 238.

The control plane VCN 216 can include a data plane mirror app tier 240 (e.g., the data plane mirror app tier 140 of FIG. 1) that can include app subnet(s) 226. The app subnet(s) 226 contained in the data plane mirror app tier 240 can include a virtual network interface controller (VNIC) 242 (e.g., the VNIC of 142) that can execute a compute instance 244 (e.g., similar to the compute instance 144 of FIG. 1). The compute instance 244 can facilitate communication between the app subnet(s) 226 of the data plane mirror app tier 240 and the app subnet(s) 226 that can be contained in a data plane app tier 246 (e.g., the data plane app tier 146 of FIG. 1) via the VNIC 242 contained in the data plane mirror app tier 240 and the VNIC 242 contained in the data plane app tier 246.

The Internet gateway 234 contained in the control plane VCN 216 can be communicatively coupled to a metadata management service 252 (e.g., the metadata management service 152 of FIG. 1) that can be communicatively coupled to public Internet 254 (e.g., public Internet 154 of FIG. 1). Public Internet 254 can be communicatively coupled to the NAT gateway 238 contained in the control plane VCN 216. The service gateway 236 contained in the control plane VCN 216 can be communicatively couple to cloud services 256 (e.g., cloud services 156 of FIG. 1).

In some examples, the data plane VCN 218 can be contained in the customer tenancy 221. In this case, the IaaS provider may provide the control plane VCN 216 for a customer, and the IaaS provider may, for a customer, set up a unique, compute instance 244 that is contained in the service tenancy 219. A compute instance 244 may allow communication between the control plane VCN 216 contained in the service tenancy 219 and the data plane VCN 218 that is contained in the customer tenancy 221. The compute instance 244 may allow resources provisioned in the control plane VCN 216 that is contained in the service tenancy 219 to be deployed or otherwise used in the data plane VCN 218 that is contained in the customer tenancy 221.

In other examples, the customer of the IaaS provider may have databases that live in the customer tenancy 221. In this example, the control plane VCN 216 can include the data plane mirror app tier 240 that can include app subnet(s) 226. The data plane mirror app tier 240 can reside in the data plane VCN 218, but the data plane mirror app tier 240 may not live in the data plane VCN 218. That is, the data plane mirror app tier 240 may have access to the customer tenancy 221, but the data plane mirror app tier 240 may not exist in the data plane VCN 218 or be owned or operated by the customer of the IaaS provider. The data plane mirror app tier 240 may be configured to make calls to the data plane VCN 218 but may not be configured to make calls to any entity contained in the control plane VCN 216. The customer may desire to deploy or otherwise use resources in the data plane VCN 218 that are provisioned in the control plane VCN 216, and the data plane mirror app tier 240 can facilitate the desired deployment or other usage of resources of the customer.

In some embodiments, the customer of the IaaS provider can apply filters to the data plane VCN 218. In this embodiment, the customer can determine what the data plane VCN 218 can access, and the customer may restrict access to public Internet 254 from the data plane VCN 218. The IaaS provider may not be able to apply filters or otherwise control access of the data plane VCN 218 to any outside networks or databases. Applying filters and controls by the customer onto the data plane VCN 218, contained in the customer tenancy 221, can help isolate the data plane VCN 218 from other customers and from public Internet 254.

In some embodiments, cloud services 256 can be called by the service gateway 236 to access services that may not exist on public Internet 254, on the control plane VCN 216, or on the data plane VCN 218. The connection between cloud services 256 and the control plane VCN 216 or the data plane VCN 218 may not be live or continuous. Cloud services 256 may exist on a different network owned or operated by the IaaS provider. Cloud services 256 may be configured to receive calls from the service gateway 236 and may be configured to not receive calls from public Internet 254. Some cloud services 256 may be isolated from other cloud services 256, and the control plane VCN 216 may be isolated from cloud services 256 that may not be in the same region as the control plane VCN 216. For example, the control plane VCN 216 may be located in “Region 1,” and cloud service “Deployment 1” may be located in Region 1 and in “Region 2.” If a call to Deployment 1 is made by the service gateway 236 contained in the control plane VCN 216 located in Region 1, the call may be transmitted to Deployment 1 in Region 1. In this example, the control plane VCN 216, or Deployment 1 in Region 1, may not be communicatively coupled to, or otherwise in communication with, Deployment 1 in Region 2.

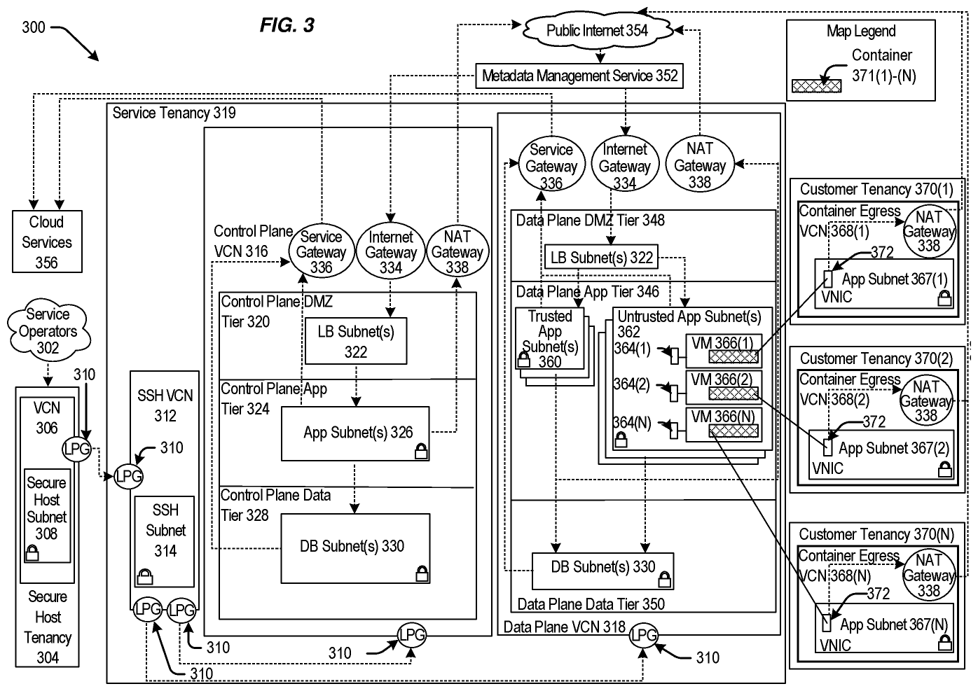

FIG. 3 is a block diagram illustrating another example pattern of an IaaS architecture 300 according to at least one embodiment. Service operators 302 (e.g., service operators 102 of FIG. 1) can be communicatively coupled to a secure host tenancy 304 (e.g., the secure host tenancy 104 of FIG. 1) that can include a virtual cloud network (VCN) 306 (e.g., the VCN 106 of FIG. 1) and a secure host subnet 308 (e.g., the secure host subnet 108 of FIG. 1). The VCN 306 can include an LPG 310 (e.g., the LPG 110 of FIG. 1) that can be communicatively coupled to an SSH VCN 312 (e.g., the SSH VCN 112 of FIG. 1) via an LPG 310 contained in the SSH VCN 312. The SSH VCN 312 can include an SSH subnet 314 (e.g., the SSH subnet 114 of FIG. 1), and the SSH VCN 312 can be communicatively coupled to a control plane VCN 316 (e.g., the control plane VCN 116 of FIG. 1) via an LPG 310 contained in the control plane VCN 316 and to a data plane VCN 318 (e.g., the data plane VCN 118 of FIG. 1) via an LPG 310 contained in the data plane VCN 318. The control plane VCN 316 and the data plane VCN 318 can be contained in a service tenancy 319 (e.g., the service tenancy 119 of FIG. 1).

The control plane VCN 316 can include a control plane DMZ tier 320 (e.g., the control plane DMZ tier 120 of FIG. 1) that can include load balancer (LB) subnet(s) 322 (e.g., LB subnet(s) 122 of FIG. 1), a control plane app tier 324 (e.g., the control plane app tier 124 of FIG. 1) that can include app subnet(s) 326 (e.g., similar to app subnet(s) 126 of FIG. 1), and a control plane data tier 328 (e.g., the control plane data tier 128 of FIG. 1) that can include DB subnet(s) 330. The LB subnet(s) 322 contained in the control plane DMZ tier 320 can be communicatively coupled to the app subnet(s) 326 contained in the control plane app tier 324 and to an Internet gateway 334 (e.g., the Internet gateway 134 of FIG. 1) that can be contained in the control plane VCN 316, and the app subnet(s) 326 can be communicatively coupled to the DB subnet(s) 330 contained in the control plane data tier 328 and to a service gateway 336 (e.g., the service gateway of FIG. 1) and a network address translation (NAT) gateway 338 (e.g., the NAT gateway 138 of FIG. 1). The control plane VCN 316 can include the service gateway 336 and the NAT gateway 338.

The data plane VCN 318 can include a data plane app tier 346 (e.g., the data plane app tier 146 of FIG. 1), a data plane DMZ tier 348 (e.g., the data plane DMZ tier 148 of FIG. 1), and a data plane data tier 350 (e.g., the data plane data tier 150 of FIG. 1). The data plane DMZ tier 348 can include LB subnet(s) 322 that can be communicatively coupled to trusted app subnet(s) 360, untrusted app subnet(s) 362 of the data plane app tier 346, and the Internet gateway 334 contained in the data plane VCN 318. The trusted app subnet(s) 360 can be communicatively coupled to the service gateway 336 contained in the data plane VCN 318, the NAT gateway 338 contained in the data plane VCN 318, and DB subnet(s) 330 contained in the data plane data tier 350. The untrusted app subnet(s) 362 can be communicatively coupled to the service gateway 336 contained in the data plane VCN 318 and DB subnet(s) 330 contained in the data plane data tier 350. The data plane data tier 350 can include DB subnet(s) 330 that can be communicatively coupled to the service gateway 336 contained in the data plane VCN 318.

The untrusted app subnet(s) 362 can include one or more primary VNICs 364 (1)-(N) that can be communicatively coupled to tenant virtual machines (VMs) 366 (1)-(N). The tenants VM 366 (1)-(N) can be communicatively coupled to a respective app subnet 367 (1)-(N) that can be contained in respective container egress VCNs 368 (1)-(N) that can be contained in respective customer tenancies 380 (1)-(N). Respective secondary VNICs 372 (1)-(N) can facilitate communication between the untrusted app subnet(s) 362 contained in the data plane VCN 318 and the app subnet contained in the container egress VCNs 368 (1)-(N). The individual container egress VCNs 368 (1)-(N) can include a NAT gateway 338 that can be communicatively coupled to public Internet 354 (e.g., public Internet 154 of FIG. 1).

The Internet gateway 334 contained in the control plane VCN 316 and contained in the data plane VCN 318 can be communicatively coupled to a metadata management service 352 (e.g., the metadata management service 152 of FIG. 1) that can be communicatively coupled to public Internet 354. Public Internet 354 can be communicatively coupled to the NAT gateway 338 contained in the control plane VCN 316 and contained in the data plane VCN 318. The service gateway 336 contained in the control plane VCN 316 and contained in the data plane VCN 318 can be communicatively couple to cloud services 356.

In some embodiments, the data plane VCN 318 can be integrated with customer tenancies 380. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether or not to run code given to the IaaS provider by the customer.

In some examples, the customer of the IaaS provider may grant temporary network access to the IaaS provider and request a function to be attached to the data plane app tier 346. Code to run the function may be executed in the VMs 366 (1)-(N), and the code may not be configured to run anywhere else on the data plane VCN 318. An individual VM 366 (1)-(N) may be connected to one customer tenancy 380. Respective containers 381 (1)-(N) contained in the VMs 366 (1)-(N) may be configured to run the code. In this case, there can be a dual isolation (e.g., the containers 381 (1)-(N) running code), where the containers 381 (1)-(N) may be contained in at least the VM 366 (1)-(N) that are contained in the untrusted app subnet(s) 362) that may help prevent incorrect or otherwise undesirable code from damaging the network of the IaaS provider or from damaging a network of a different customer. The containers 381 (1)-(N) may be communicatively coupled to the customer tenancy 380 and may be configured to transmit or receive data from the customer tenancy 380. The containers 381 (1)-(N) may not be configured to transmit or receive data from any other entity in the data plane VCN 318. Upon completion of running the code, the IaaS provider may kill or otherwise dispose of the containers 381 (1)-(N).

In some embodiments, the trusted app subnet(s) 360 may run code that may be owned or operated by the IaaS provider. In this embodiment, the trusted app subnet(s) 360 may be communicatively coupled to the DB subnet(s) 330 and be configured to execute CRUD operations in the DB subnet(s) 330. The untrusted app subnet(s) 362 may be communicatively coupled to the DB subnet(s) 330, but in this embodiment, the untrusted app subnet(s) may be configured to execute read operations in the DB subnet(s) 330. The containers 381 (1)-(N) that can be contained in the VM 366 (1)-(N) of a customer and that may run code from the customer may not be communicatively coupled with the DB subnet(s) 330.

In other embodiments, the control plane VCN 316 and the data plane VCN 318 may not be directly communicatively coupled. In this embodiment, there may be no direct communication between the control plane VCN 316 and the data plane VCN 318. However, communication can occur indirectly through at least one method. An LPG 310 may be established by the IaaS provider that can facilitate communication between the control plane VCN 316 and the data plane VCN 318. In another example, the control plane VCN 316 or the data plane VCN 318 can make a call to cloud services 356 via the service gateway 336. For example, a call to cloud services 356 from the control plane VCN 316 can include a request for a service that can communicate with the data plane VCN 318.

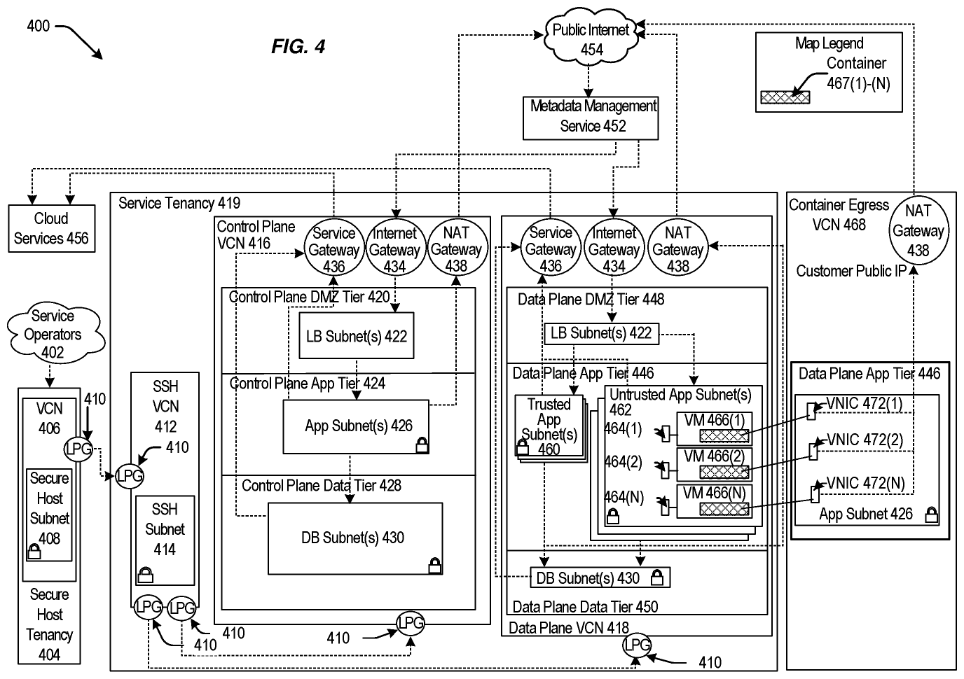

FIG. 4 is a block diagram illustrating another example pattern of an IaaS architecture 400 according to at least one embodiment. Service operators 402 (e.g., service operators 102 of FIG. 1) can be communicatively coupled to a secure host tenancy 404 (e.g., the secure host tenancy 104 of FIG. 1) that can include a virtual cloud network (VCN) 406 (e.g., the VCN 106 of FIG. 1) and a secure host subnet 408 (e.g., the secure host subnet 108 of FIG. 1). The VCN 406 can include an LPG 410 (e.g., the LPG 110 of FIG. 1) that can be communicatively coupled to an SSH VCN 412 (e.g., the SSH VCN 112 of FIG. 1) via an LPG 410 contained in the SSH VCN 412. The SSH VCN 412 can include an SSH subnet 414 (e.g., the SSH subnet 114 of FIG. 1), and the SSH VCN 412 can be communicatively coupled to a control plane VCN 416 (e.g., the control plane VCN 116 of FIG. 1) via an LPG 410 contained in the control plane VCN 416 and to a data plane VCN 418 (e.g., the data plane VCN 118 of FIG. 1) via an LPG 410 contained in the data plane VCN 418. The control plane VCN 416 and the data plane VCN 418 can be contained in a service tenancy 419 (e.g., the service tenancy 119 of FIG. 1).

The control plane VCN 416 can include a control plane DMZ tier 420 (e.g., the control plane DMZ tier 120 of FIG. 1) that can include LB subnet(s) 422 (e.g., LB subnet(s) 122 of FIG. 1), a control plane app tier 424 (e.g., the control plane app tier 124 of FIG. 1) that can include app subnet(s) 426 (e.g., app subnet(s) 126 of FIG. 1), and a control plane data tier 428 (e.g., the control plane data tier 128 of FIG. 1) that can include DB subnet(s) 430 (e.g., DB subnet(s) 330 of FIG. 3). The LB subnet(s) 422 contained in the control plane DMZ tier 420 can be communicatively coupled to the app subnet(s) 426 contained in the control plane app tier 424 and to an Internet gateway 434 (e.g., the Internet gateway 134 of FIG. 1) that can be contained in the control plane VCN 416, and the app subnet(s) 426 can be communicatively coupled to the DB subnet(s) 430 contained in the control plane data tier 428 and to a service gateway 436 (e.g., the service gateway of FIG. 1) and a network address translation (NAT) gateway 438 (e.g., the NAT gateway 138 of FIG. 1). The control plane VCN 416 can include the service gateway 436 and the NAT gateway 438.

The data plane VCN 418 can include a data plane app tier 446 (e.g., the data plane app tier 146 of FIG. 1), a data plane DMZ tier 448 (e.g., the data plane DMZ tier 148 of FIG. 1), and a data plane data tier 450 (e.g., the data plane data tier 150 of FIG. 1). The data plane DMZ tier 448 can include LB subnet(s) 422 that can be communicatively coupled to trusted app subnet(s) 460 (e.g., trusted app subnet(s) 360 of FIG. 3) and untrusted app subnet(s) 462 (e.g., untrusted app subnet(s) 362 of FIG. 3) of the data plane app tier 446 and the Internet gateway 434 contained in the data plane VCN 418. The trusted app subnet(s) 460 can be communicatively coupled to the service gateway 436 contained in the data plane VCN 418, the NAT gateway 438 contained in the data plane VCN 418, and DB subnet(s) 430 contained in the data plane data tier 450. The untrusted app subnet(s) 462 can be communicatively coupled to the service gateway 436 contained in the data plane VCN 418 and DB subnet(s) 430 contained in the data plane data tier 450. The data plane data tier 450 can include DB subnet(s) 430 that can be communicatively coupled to the service gateway 436 contained in the data plane VCN 418.

The untrusted app subnet(s) 462 can include primary VNICs 464 (1)-(N) that can be communicatively coupled to tenant virtual machines (VMs) 466 (1)-(N) residing within the untrusted app subnet(s) 462. The individual tenant VMs 466 (1)-(N) can run code in a respective container 467 (1)-(N) and be communicatively coupled to an app subnet 426 that can be contained in a data plane app tier 446 that can be contained in a container egress VCN 468. Respective secondary VNICs 472 (1)-(N) can facilitate communication between the untrusted app subnet(s) 462 contained in the data plane VCN 418 and the app subnet contained in the container egress VCN 468. The container egress VCN can include a NAT gateway 438 that can be communicatively coupled to public Internet 454 (e.g., public Internet 154 of FIG. 1).

The Internet gateway 434 contained in the control plane VCN 416 and contained in the data plane VCN 418 can be communicatively coupled to a metadata management service 452 (e.g., the metadata management service 152 of FIG. 1) that can be communicatively coupled to public Internet 454. Public Internet 454 can be communicatively coupled to the NAT gateway 438 contained in the control plane VCN 416 and contained in the data plane VCN 418. The service gateway 436 contained in the control plane VCN 416 and contained in the data plane VCN 418 can be communicatively couple to cloud services 456.

In some examples, the pattern illustrated by the architecture of block diagram 400 of FIG. 4 may be considered an exception to the pattern illustrated by the architecture of block diagram 300 of FIG. 3 and may be desirable for a customer of the IaaS provider if the IaaS provider cannot directly communicate with the customer (e.g., a disconnected region). The respective containers 467 (1)-(N) that are contained in the VMs 466 (1)-(N) for a customer can be accessed in real-time by the customer. The containers 467 (1)-(N) may be configured to make calls to respective secondary VNICs 472 (1)-(N) contained in app subnet(s) 426 of the data plane app tier 446 that can be contained in the container egress VCN 468. The secondary VNICs 472 (1)-(N) can transmit the calls to the NAT gateway 438 that may transmit the calls to public Internet 454. In this example, the containers 467 (1)-(N) that can be accessed in real time by the customer can be isolated from the control plane VCN 416 and can be isolated from other entities contained in the data plane VCN 418. The containers 467 (1)-(N) may also be isolated from resources from other customers.

In other examples, the customer can use the containers 467 (1)-(N) to call cloud services 456. In this example, the customer may run code in the containers 467 (1)-(N) that request a service from cloud services 456. The containers 467 (1)-(N) can transmit this request to the secondary VNICs 472 (1)-(N) that can transmit the request to the NAT gateway that can transmit the request to public Internet 454. Public Internet 454 can transmit the request to LB subnet(s) 422 contained in the control plane VCN 416 via the Internet gateway 434. In response to determining the request is valid, the LB subnet(s) can transmit the request to app subnet(s) 426 that can transmit the request to cloud services 456 via the service gateway 436.

It should be appreciated that IaaS architectures 100, 200, 300, and 400 may include components that are different and/or additional to the components shown in the figures. Further, the embodiments shown in the figures represent non-exhaustive examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as execution of a particular application and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally, or alternatively, a physical node may be a generic machine that is configured to execute various virtual machines and/or applications performing respective functions. A physical link is a physical medium connecting two or more physical nodes.

Examples of links include a coaxial cable, an unshielded twisted cable, a copper cable, and an optical fiber.

A computer network may be an overlay network. An overlay network is a logical network implemented on top of another network such as a physical network. A node in an overlay network corresponds to a respective node in the underlying network. Hence, a node in an overlay network is associated with both an overlay address (to address to the overlay node) and an underlay address (to address the underlay node that implements the overlay node). An overlay node may be a digital device and/or a software process, such as a virtual machine, an application instance, or a thread. A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis. Network resources assigned to a request and/or client may be scaled up or down based on one or more of the following: (a) the computing services requested by a particular client, (b) the aggregated computing services requested by a particular tenant, or (c) the aggregated computing services requested of the computer network. Such a computer network may be referred to as a “cloud network.”

In an embodiment, a service provider provides a cloud network to one or more end users. Various service models may be implemented by the cloud network, including, but not limited, to Software-as-a-Service (SaaS), Platform-as-a-Service (PaaS), and Infrastructure-as-a-Service (IaaS). In SaaS, a service provider provides end users the capability to use the service provider's applications that are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including, but not limited to, a private cloud, a public cloud, and a hybrid cloud. In a private cloud, network resources are provisioned for exclusive use by a particular group of one or more entities; the term “entity” as used herein refers to a corporation, organization, person, or other entity. The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QOS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, a tenant is associated with a tenant ID. A network resource of the multi-tenant computer network is tagged with a tenant ID. A tenant is permitted access to a particular network resource when the tenant and the particular network resources are associated with a same tenant ID.

In an embodiment, a tenant is associated with a tenant ID. An application, implemented by the computer network, is tagged with a tenant ID. Additionally, or alternatively, a data structure and/or dataset, stored by the computer network, is tagged with a tenant ID. A tenant is permitted access to a particular application, data structure, and/or dataset when the tenant and the particular application, data structure, and/or dataset are associated with a same tenant ID.

As an example, a database implemented by a multi-tenant computer network may be tagged with a tenant ID. A tenant associated with the corresponding tenant ID may access data of a particular database. As another example, an entry in a database implemented by a multi-tenant computer network may be tagged with a tenant ID. A tenant associated with the corresponding tenant ID may access data of a particular entry. However, multiple tenants may share the database.

In an embodiment, a subscription list identifies a set of tenants, and, for a tenant, a set of applications that the tenant is authorized to access. For an application, a list of tenant IDs of tenants authorized to access the application is stored. A tenant is permitted access to a particular application when the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may be transmitted to other devices within the same tenant overlay network. Encapsulation tunnels are used to prohibit any transmissions from a source device on a tenant overlay network to devices in other tenant overlay networks. Specifically, the packets received from the source device are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

4. COMPUTER SYSTEM

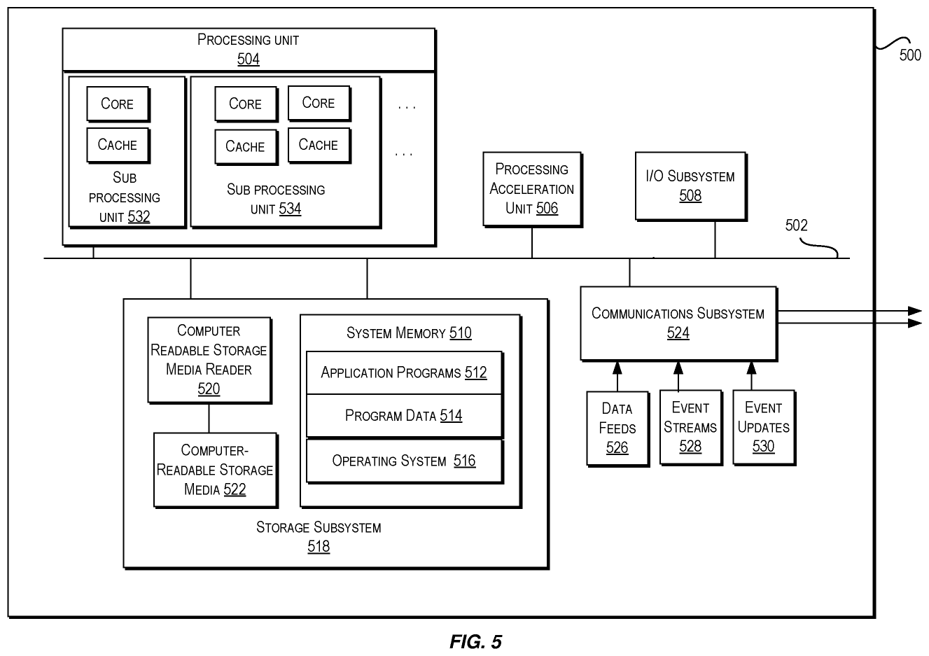

FIG. 5 illustrates an example computer system 500. An embodiment of the disclosure may be implemented upon the computer system 500. As shown in FIG. 5, computer system 500 includes a processing unit 504 that communicates with peripheral subsystems via a bus subsystem 502. These peripheral subsystems may include a processing acceleration unit 506, an I/O subsystem 508, a storage subsystem 518, and a communications subsystem 524. Storage subsystem 518 includes tangible computer-readable storage media 522 and a system memory 510.

Bus subsystem 502 provides a mechanism for letting the various components and subsystems of computer system 500 to communicate with each other as intended. Although bus subsystem 502 is shown schematically as a single bus, alternative embodiments of the bus subsystem may utilize multiple buses. Bus subsystem 502 may be any of several types of bus structures, including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus. Additionally, such architectures may be implemented as a Mezzanine bus manufactured to the IEEE P1386.1 standard.

Processing unit 504 controls the operation of computer system 500. Processing unit 504 can be implemented as one or more integrated circuits (e.g., a conventional microprocessor or microcontroller). One or more processors may be included in processing unit 504. These processors may include single core or multicore processors. In certain embodiments, processing unit 504 may be implemented as one or more independent processing units 532 and/or 534 with single or multicore processors included in a processing unit. In other embodiments, processing unit 504 may also be implemented as a quad-core processing unit formed by integrating two dual-core processors into a single chip.

In various embodiments, processing unit 504 can execute a variety of programs in response to program code and can maintain multiple concurrently executing programs or processes. At any given time, the program code to be executed can be wholly or partially resident in processing unit 504 and/or in storage subsystem 518. Through suitable programming, processing unit 504 can provide various functionalities described above. Computer system 500 may additionally include a processing acceleration unit 506 that can include a digital signal processor (DSP), a special-purpose processor, and/or the like.

I/O subsystem 508 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include medical imaging input devices such as computed tomography, magnetic resonance imaging, position emission tomography, or medical ultrasonography devices. User interface input devices may also include audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include any type of device and mechanism for outputting information from computer system 500 to a user or other computer. For example, user interface output devices may include, without limitation, a variety of display devices that visually convey text, graphics and audio/video information, such as monitors, printers, speakers, headphones, automotive navigation systems, plotters, voice output devices, and modems.

Computer system 500 may comprise a storage subsystem 518 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 504 provide the functionality described above. Storage subsystem 518 may also provide a repository for storing data used in accordance with the present disclosure.

As depicted in the example in FIG. 5, storage subsystem 518 can include various components, including a system memory 510, computer-readable storage media 522, and a computer readable storage media reader 520. System memory 510 may store program instructions, such as application programs 512, that are loadable and executable by processing unit 504. System memory 510 may also store data, such as program data 514, that is used during the execution of the instructions and/or data that is generated during the execution of the program instructions. Various programs may be loaded into system memory 510 including, but not limited to, client applications, Web browsers, mid-tier applications, relational database management systems (RDBMS), virtual machines, containers, etc.

System memory 510 may also store an operating system 516. Examples of operating system 516 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 500 executes one or more virtual machines, the virtual machines along with their guest operating systems (GOSs) may be loaded into system memory 510 and executed by one or more processors or cores of processing unit 504.

System memory 510 can come in different configurations depending upon the type of computer system 500. For example, system memory 510 may be volatile memory (such as random access memory (RAM)) and/or non-volatile memory (such as read-only memory (ROM), flash memory, etc.). Different types of RAM configurations may be provided, including a static random access memory (SRAM), a dynamic random access memory (DRAM), and others. In some implementations, system memory 510 may include a basic input/output system (BIOS) containing basic routines that help to transfer information between elements within computer system 500 such as during start-up.

Computer-readable storage media 522 may represent remote, local, fixed, and/or removable storage devices plus storage media for temporarily and/or more permanently containing, storing, computer-readable information for use by computer system 500, including instructions executable by processing unit 504 of computer system 500.

Computer-readable storage media 522 can include any appropriate media known or used in the art, including storage media and communication media, such as but not limited to volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 522 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 522 may include, but is not limited to, Zip® drives, flash memory cards, universal serial bus (USB) flash drives, secure digital (SD) cards, DVD disks, digital video tape, and the like. Computer-readable storage media 522 may also include solid-state drives (SSD) based on non-volatile memory, such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 500.

Machine-readable instructions executable by one or more processors or cores of processing unit 504 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 524 provides an interface to other computer systems and networks. Communications subsystem 524 serves as an interface for receiving data from and transmitting data to other systems from computer system 500. For example, communications subsystem 524 may enable computer system 500 to connect to one or more devices via the Internet. In some embodiments, communications subsystem 524 can include radio frequency (RF) transceiver components to access wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments, communications subsystem 524 can provide wired network connectivity (e.g., Ethernet) in addition to or instead of a wireless interface.

In some embodiments, communications subsystem 524 may also receive input communication in the form of structured and/or unstructured data feeds 526, event streams 528, event updates 530, and the like on behalf of one or more users who may use computer system 500.

By way of example, communications subsystem 524 may be configured to receive data feeds 526 in real-time from users of social networks and/or other communication services, such as Twitter® feeds, Facebook® updates, web feeds such as Rich Site Summary (RSS) feeds, and/or real-time updates from one or more third party information sources.

Additionally, communications subsystem 524 may be configured to receive data in the form of continuous data streams. The continuous data streams may include event streams 528 of real-time events and/or event updates 530 that may be continuous or unbounded in nature with no explicit end. Examples of applications that generate continuous data may include sensor data applications, financial tickers, network performance measuring tools (e.g., network monitoring and traffic management applications), clickstream analysis tools, automobile traffic monitoring, and the like.

Communications subsystem 524 may also be configured to output the structured and/or unstructured data feeds 526, event streams 528, event updates 530, and the like to one or more databases that may be in communication with one or more streaming data source computers coupled to computer system 500.

Computer system 500 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 500 depicted in FIG. 5 is intended as a non-limiting example. Many other configurations having more or fewer components than the system depicted in FIG. 5 are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

4. AUTOMATIC PORT ASSIGNMENT ARCHITECTURE

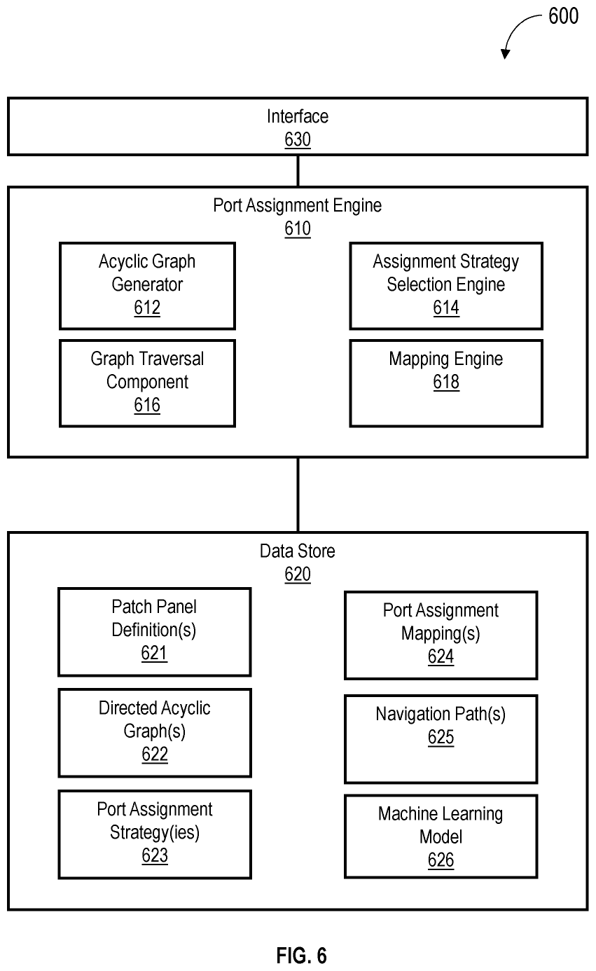

FIG. 6 illustrates a system 600 in accordance with one or more embodiments. As illustrated in FIG. 6, system 600 includes a port assignment engine 610, a data store 620, and an interface 630. In one or more embodiments, the system 600 may include more or fewer components than the components illustrated in FIG. 6. The components illustrated in FIG. 6 may be local to or remote from one another. The components illustrated in FIG. 6 may be implemented in software and/or hardware. The components may be distributed over multiple applications and/or machines. Multiple components may be combined into one application and/or machine. Operations described with respect to one component may instead be performed by another component.

In an embodiment, the system 600 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

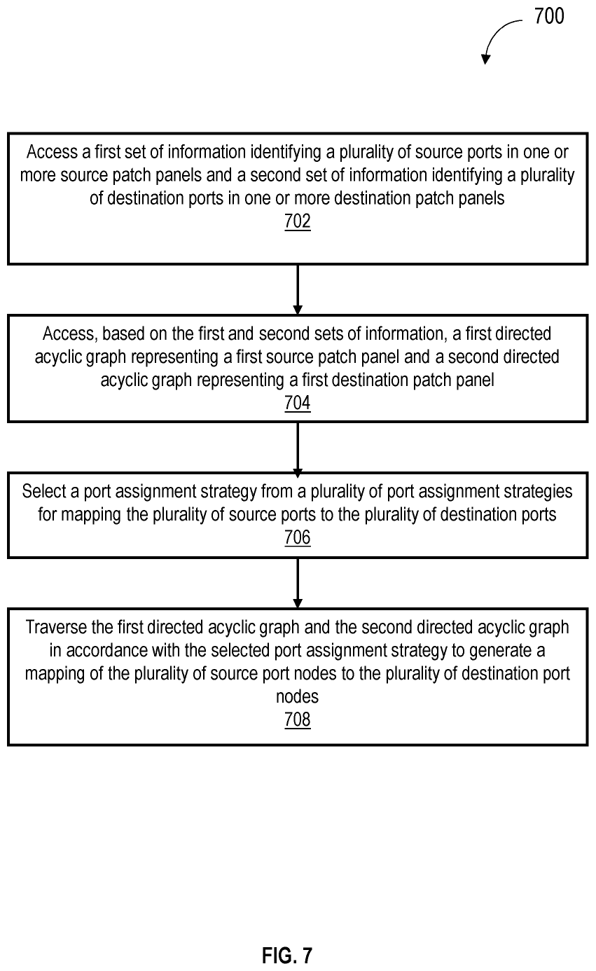

In one or more embodiments, port assignment engine 610 refers to hardware and/or software configured to perform operations described herein for automatically assigning source patch panel ports to destination patch panel ports. Port assignment engine 610 may include one or more functional components, such as an acyclic graph generator 612, an assignment strategy selection engine 614, a graph traversal component 616, and a mapping engine 618. Examples of operations for automatically assigning source patch panel ports to destination patch panel ports are described below with reference to FIG. 7.

In one or more embodiments, the acyclic graph generator 612 creates a directed acyclic graph 622 that represents a patch panel based on a patch panel definition 621. A patch panel definition 621 for a particular patch panel may include information identifying the rack where the patch panel is installed, how many shelves are present in the patch panel, how many modules are on a shelf, and how many ports are in a module.

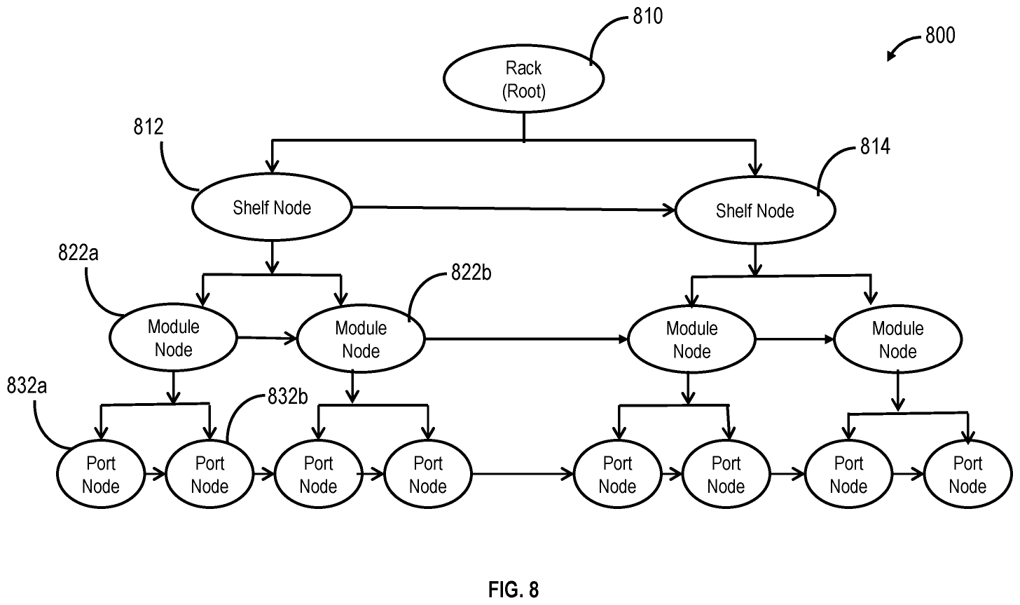

The directed acyclic graph 622 for a particular patch panel may include a root node corresponding to the rack where the patch panel is installed, a plurality of shelf nodes corresponding respectively to the shelves of the patch panel, a plurality of module nodes corresponding respectively to the modules of the patch panel, and a plurality of port nodes corresponding respectively to the ports of the patch panel. The nodes may be directionally and sequentially connected. The port nodes may include a location identifier of the corresponding patch panel port, e.g., a rack ID, a shelf ID, a module ID, and a port number. The port nodes may also include a location identifier of another port that is mapped to the port corresponding to the node or an indication that the port corresponding to the node is unassigned. An example of a directed acyclic graph is described below with reference to FIG. 8.

In one or more embodiments, the assignment strategy selection engine 614 selects a particular port assignment strategy 623 for use during an automatic port assignment operation. For patch panels that connect fiber optic cables, assignment strategy selection engine 614 may calculate how many ports to assign at a time based on the number of optical fibers to be connected and may select a port assignment strategy based on the calculation. Assignment strategy selection engine 614 may select a port assignment strategy 623 based on parameters such as how many source patch panels and how many destination patch panels are to be connected. Other parameters may include the types of patch panels to assign, a physical distance between the patch panels, a relative position of a source patch panel to a destination patch panel, and/or if some of the ports in the source and/or destination patch panels are already assigned. Some of the parameters may be received via the interface 630. Assignment strategy selection engine 614 may determine other parameters from a directed acyclic graph for a patch panel. In one or more embodiments, assignment strategy selection engine 614 may apply a machine learning model 626 to the parameters to select a port assignment strategy. Machine learning model 626 is described below in Section 7, entitled “Machine Learning.”

In one or more embodiments, the graph traversal component 616 examines nodes within a directed acyclic graph and traverses the graph sequentially from node to node. Graph traversal component 616 can determine if a port corresponding to a port node is unassigned. If a port corresponding to a port node is assigned, graph traversal component can determine to what other node the port is assigned.

In one or more embodiments, the mapping engine 618 generates a port assignment mapping 624 between source patch panel ports and destination patch panel ports that can be referred to by a person physically connecting the patch panel ports in the data center. A port assignment mapping 624 may be a table or spreadsheet file that represents the ports in one or more source patch panels and the ports in one or more destination patch panels. For example, a port assignment mapping may include rows and columns of table cells. A row in the table may correspond to a shelf. A column or a grouping of columns may correspond to a module. A table cell may correspond to a patch panel port. The port number of a port may be represented as a text value of the table cell associated with the port. The graph traversal component 616 may be able to locate a table cell in the port assignment mapping that corresponds to a port node in a directed acyclic graph from the location identifier of the port in the graph node, for example, locating the column and row corresponding to the port based on the rack ID, shelf ID, module ID, and port number in the node. In some embodiments, one or more source patch panels may be represented on the same spreadsheet as one or more destination patch panels, for example, with a blank column between the representations of a source patch panel and a destination patch panel and with a blank row between the representations of two source patch panels.

Once the port assignment mapping is generated, the mapping engine 618 may modify the port assignment mapping to reflect the mapping of source ports to destination ports. For example, when a source node in rack 1, shelf 1, module A, port 1 is mapped to a destination node in rack 1, shelf 2, module B, port 1, the value of the table cell for the source node may be modified to include identifying information for the destination node. Similarly, the value of the table cell for the destination node may be modified to include identifying information for the source node. In one or more embodiments, the mapping engine 618 may apply a visual indicator to the table cells corresponding to the ports that were mapped together as a further visual aid for the human engineer who will connect the corresponding physical ports. The visual indicator may be a fill color, a border color, or shading that has not already been applied in the table or spreadsheet.

In some cases, a patch panel may include two or more separate navigation paths 625. A navigation path may indicate that one set of ports in a source patch panel should be connected to one destination patch panel, and another set of ports in the source patch panel should be connected to a different destination patch panel. Connecting one source patch panel to two or more different destination patch panels with different navigation paths may enable, for example, a primary connection from the source to a destination and a backup path from the source patch panel to a different destination patch panel. If the primary connection were to fail, the backup connection could be used instead.

In one or more embodiments, the acyclic graph generator 612 may generate or modify a directed acyclic graph in accordance with a navigation path defined for a source patch panel. Acyclic graph generator 612 may, for example, generate a directed acyclic graph and then remove a connection from one port node (port node x) to the next adjacent port node (port node x1) when port node x1 is in a different navigation path from port node x. In some embodiments, the acyclic graph generator 612 may connect port node x to another port node or to another shelf node or module node such that, when the directed acyclic graph is traversed during port mapping, the graph traversal component 616 proceeds from port node x to the next port node that is within the same navigation path as port node x without visiting port node x1 or any subsequent port nodes within the second navigation path.

In one or more embodiments, a data store 620 is any type of storage unit and/or device (e.g., a file system, database, collection of tables, or any other storage mechanism) for storing data. Further, a data store 620 may include multiple different storage units and/or devices. The multiple different storage units and/or devices may or may not be of the same type or located at the same physical site. Further, a data store 620 may be implemented or executed on the same computing system as port assignment engine 610. Additionally, or alternatively, a data store 620 may be implemented or executed on a computing system separate from port assignment engine 610. The data store 620 may be communicatively coupled to port assignment engine 610 via a direct connection or via a network.

Information describing patch panel definitions 621, directed acyclic graphs 622, port assignment strategies 623, port assignment mappings 624, navigation paths 625, and a machine learning model 626 may be implemented across any of components within the system 600. However, this information is illustrated within the data store 620 for purposes of clarity and explanation.

In one or more embodiments, interface 630 refers to hardware and/or software configured to facilitate communications between a user and the port assignment engine 610. For example, interface 630 may enable the user to select patch panel definitions and to initiate a port assignment process. Interface 630 may display a visual representation of a port assignment mapping.

Interface 630 renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of interface 630 are specified in different languages. The behavior of user interface elements is specified in a dynamic programming language such as JavaScript. The content of user interface elements is specified in a markup language, such as hypertext markup language (HTML) or XML User Interface Language (XUL). The layout of user interface elements is specified in a style sheet language such as Cascading Style Sheets (CSS). Alternatively, interface 630 is specified in one or more other languages, such as Java, C, or C++.

5. ASSIGNING PORTS AUTOMATICALLY

FIG. 7 illustrates an example set of operations 700 for automatically assigning source patch panel ports to destination patch panel ports. One or more operations illustrated in FIG. 7 may be modified, rearranged, or omitted. Accordingly, the particular sequence of operations illustrated in FIG. 7 should not be construed as limiting the scope of one or more embodiments.

In an embodiment, the system accesses a first set of information identifying a plurality of source ports in one or more source patch panels and a second set of information identifying a plurality of destination ports in one or more destination patch panels (Operation 702). The system may receive a request to assign the ports of the one or more source patch panels to the one or more destination patch panels, for example, via an interface. The request may include identifying information for the one or more source patch panels and the one or more destination patch panels. The identifying information may include, for example, identifiers for one or more racks holding the patch panels and identifiers and/or locations within a rack of the physical patch panels.

The system may access, based on the first set of information, a first directed acyclic graph representing a first source patch panel. The system may access, based on the second set of information, a second directed acyclic graph representing a first destination patch panel (Operation 704). The system may use the identifying information for a patch panel to locate and open an existing directed acyclic graph corresponding to that patch panel.

The system may select a port assignment strategy from a plurality of port assignment strategies for mapping the plurality of source ports to the plurality of destination ports (Operation 706). The system may select a default port assignment strategy if no port assignment strategy was specified in the request to assign ports. Alternatively, the system may apply a trained machine learning model to the respective directed acyclic graphs for the source and destination patch panels to select a port assignment strategy.

The system may traverse the first directed acyclic graph and the second directed acyclic graph in accordance with the selected port assignment strategy to generate a mapping of the plurality of source port nodes to the plurality of destination port nodes (Operation 708). The system may traverse the port nodes of first directed acyclic graph sequentially to locate an unassigned source port node. When an unassigned port node is identified, the system may traverse the port nodes of the second directed acyclic graph sequentially to locate an unassigned destination port node. Traversing the nodes sequentially in a directed acyclic graph may involve selecting one of any number of unidirectional paths in the directed acyclic graph. For example, when a patch panel includes two or more separate navigation paths, the system may select one of the navigation paths to traverse. The system may then assign the unassigned source port node to the unassigned destination port node and may update a port assignment mapping for the first and second patch panels to indicate that the source and destination nodes are assigned to one another. The system may continue the traversal pattern, node by node, until no source port nodes remain to be mapped.

In a scenario where there are multiple destination patch panels, e.g., Panel A and panel B, one port assignment strategy may be to assign all available ports in Panel A to the ports in a source patch panel before assigning ports from Panel B. The system may assign ports on a port-by-port basis. For example, the system may assign source port 1 to Panel A, port 1. Next, the system may assign source port 2 to Panel A, port 2, then source port 3 to Panel A, port 3, and so forth until Panel A has no unassigned ports. Then, if there are still ports to assign in the source patch panel, the process repeats with Panel B.

The system may assign ports in groups, for example, according to a number calculated from the number of fibers to connect. The system may traverse the port nodes of the source directed acyclic graph sequentially to locate a grouping of the specified number of adjacent unassigned source port nodes. The system may traverse the destination directed acyclic graph to locate a group of the specified number of unassigned adjacent destination port nodes. The system may assign the individual unassigned source nodes within the grouping to the individual unassigned port nodes in the located grouping. For example, the system may assign source ports 1-8 to Panel A, ports 1-8, then source ports 9-16 to Panel A, ports 9-16, and so forth until Panel A has no remaining groups of sequential unassigned ports. Then, if there are still ports to assign in the source, the process repeats with Panel B. For this port assignment strategy, source ports may be assigned sequentially to destination ports until the source ports to be assigned are assigned and/or no groups of sequential destination ports remain for the group size.

Another port assignment strategy may be to alternate between destination patch panels when assigning destination ports to the source patch panel ports. For example, the system may assign source port 1 to Panel A, port 1. Next the system may assign source port 2 to Panel B, port 1. Then, the system may assign source port 3 to Panel A, port 2, and so forth. This may continue until the source ports to be assigned are assigned and/or until no unassigned destination ports remain.

When the traversal and mapping operations are complete, the resulting mapping can be used by a human engineer as a reference to create the physical connections among the patch panels.

6. EXAMPLE EMBODIMENT

A detailed example is described below for purposes of clarity. Components and/or operations described below should be understood as one specific example that may not be applicable to certain embodiments. Accordingly, components and/or operations described below should not be construed as limiting the scope of any of the claims.

FIG. 8 illustrates an example of a directed acyclic graph 800 in accordance with one or more embodiments. Graph 800 corresponds to a patch panel having two ports per module, two modules per shelf, and two shelves in the patch panel installed on a rack. The rack may be represented as a root node 810. The root node may include identifying information about the rack, such as an identifier of the physical rack, how many shelves the rack has, and the elevation location of the rack.

The two shelves may be represented as shelf nodes 812 and 814. A shelf node may include information about the shelf, such as an identifier of the shelf, the identifier of the shelf's rack, how many modules the shelf has, and the location of the shelf in the rack. The root node is unidirectionally connected to the shelf nodes. A shelf node may be unidirectionally connected to an adjacent shelf node, e.g., shelf node 812 is unidirectionally connected to shelf node 814.

A shelf node is also unidirectionally connected to the module nodes for that shelf, e.g., shelf node 812 is connected to module node 822a and module node 822b. A module node may include information about the module, such as a module identifier, identifiers for the module's shelf and rack, and how many ports the module has. A module node may be unidirectionally connected to an adjacent module node, e.g., module node 822a is unidirectionally connected to module node 822b. The last module node for one shelf may be unidirectionally connected to the first module for an adjacent shelf.

A module node is also unidirectionally connected to port nodes for that module, e.g., module node 822a is connected to port node 832a and 832b. A port node may include information about the node, such as a port identifier, and the identifiers of the node's module, shelf, and rack. The last port node for one module may be unidirectionally connected to the first port node of an adjacent module.

7. MACHINE LEARNING

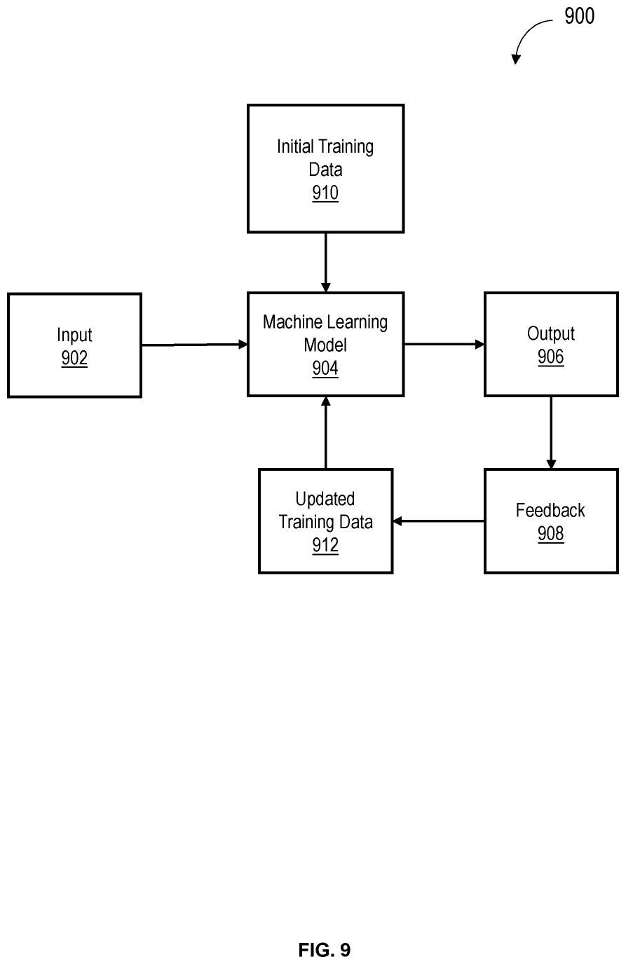

FIG. 9 illustrates a machine learning process 900 according to one or more embodiments. A machine learning model 904 may be iteratively trained on initial training data 910 to map a set of input variables to an output variable. The initial training data 910 may include a source directed acyclic graph corresponding to a source patch panel, a destination directed acyclic graph corresponding to a destination patch panel, a mapping between the source patch panel and the destination patch panel, and a port assignment strategy applied to generate the mapping.

Once trained initially, the machine learning model 904 may act on an input 902, such as directed acyclic graphs for the source patch panels and destination patch panels. The output 906 may be a port assignment strategy.

The training data may be updated based on, for example, feedback 908 on the accuracy of the current machine learning model 904. Updated training data 912 is fed back into the machine learning algorithm that, in turn, updates the machine learning model 904.

A machine learning model 904 is trained such that the model best fits the datasets of training data to the labels or outputs of the training data. Additionally, or alternatively, machine learning model 904 is trained such that when the model is applied to the datasets of the training data, a maximum number of results determined by the model matches the labels or outputs of the training data. Different target models may be generated based on different machine learning algorithms and/or different sets of training data.

A machine learning algorithm may include supervised components and/or unsupervised components. Various types of algorithms may be used, such as linear regression, logistic regression, linear discriminant analysis, classification and regression trees, naïve Bayes, k-nearest neighbors, learning vector quantization, support vector machine, bagging and random forest, boosting, backpropagation, and/or clustering.

8. PRACTICAL APPLICATIONS, ADVANTAGES, AND IMPROVEMENTS

One challenge in a conventional manual port assignment process is that patch panels vary in type, size, and layout. One patch panel may have port 1 in a top left position, while another patch panel may have port 1 in a bottom right position, resulting in respectively different navigation patterns from port to port. A source patch panel with one number of ports and one navigation pattern, e.g., top left to bottom right, may need to be connected to a destination patch panel having a different number of ports and/or a different navigation pattern, e.g., bottom right to top left. Keeping track of these differences adds time and complexity to the manual assignment process, particularly when multiplied over thousands of connections.

Conventional assignment processes make it difficult for the design engineer to determine if given ports on a rack are already used to avoid collisions or duplication. The design engineer may also find it difficult to know in advance if a given set of destination racks are enough or available to accommodate ports of a given source patch panel. Some racks may have already been partially connected and need to assign the remaining available ports. In this case, the next available ports to be assigned should be tracked.

One or more embodiments represent a patch panel as a directed acyclic graph. A directed acyclic graph eliminates the need to consider the layout and navigation patterns of the various patch panel types because the directed acyclic graph connects the port nodes sequentially, independent of the physical layout of the ports. The assignment process can therefore traverse the directed acyclic graph sequentially for any patch panel type. The one or more embodiments also reduce the time needed to assign large numbers of ports. In an example, a port assignment task that took sixteen engineer hours to complete was completed in about thirty seconds by an embodiment. Further, the one or more embodiments also improve troubleshooting, streamline rack management, reduce downtime, track port assignments in real-time, and enable a scalable infrastructure.

9. MISCELLANEOUS; EXTENSIONS

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and reasonable effort made to prevent their use in any manner that might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions that, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of patent protection, and what is intended by the applicants to be the scope of patent protection, is the literal and equivalent scope of the set of claims that issue from this application, in the specific form in which such claims issue, including any subsequent correction.

What is claimed is:

1. One or more non-transitory computer readable media comprising instructions that, when executed by one or more hardware processors, cause performance of operations comprising:
accessing a first set of information identifying a plurality of source ports in one or more source patch panels and a second set of information identifying a plurality of destination ports in one or more destination patch panels;
accessing, based on the first set of information, a first directed acyclic graph representing a first source patch panel of the one or more source patch panels, the first directed acyclic graph comprising a plurality of source port nodes corresponding respectively to the plurality of source ports in the first source patch panel;
accessing, based on the second set of information, a second directed acyclic graph representing a first destination patch panel of the one or more destination patch panels, the second directed acyclic graph comprising a plurality of destination port nodes corresponding respectively to the plurality of destination ports in the first destination patch panel;
selecting a port assignment strategy from a plurality of port assignment strategies for mapping the plurality of source ports to the plurality of destination ports; and
traversing the first directed acyclic graph and the second directed acyclic graph in accordance with the selected port assignment strategy to generate a mapping of the plurality of source port nodes to the plurality of destination port nodes.

2. The non-transitory media of claim 1, wherein traversing the first directed acyclic graph and the second directed acyclic graph comprises mapping the plurality of source port nodes to the plurality of destination port nodes based on a) a first order for traversing the plurality of source port nodes using the selected port assignment strategy and b) a second order for traversing the plurality of destination port nodes are traversed using the selected port assignment strategy.

3. The non-transitory media of claim 1, wherein the operations further comprise generating the first directed acyclic graph based on a navigation path defined for the first source patch panel.

4. The non-transitory media of claim 1, wherein the operations further comprise:
receiving a source patch panel definition corresponding to the first source patch panel and a destination patch panel definition corresponding to the first destination patch panel;
generating the first directed acyclic graph for the first source patch panel based on the source patch panel definition; and
generating the second directed acyclic graph for the first destination patch panel based on the destination patch panel definition.

5. The non-transitory media of claim 4, wherein a patch panel definition for a patch panel includes a number of shelves in the patch panel, a number of modules per shelf in the patch panel, and a number of ports per module in the patch panel.

6. The non-transitory media of claim 1, wherein a directed acyclic graph comprises:
a root node corresponding to a rack;
a first number of sequentially connected shelf nodes connected to the root node, the first number corresponding to a number of shelves in the rack;
for a respective shelf node: a second number of sequentially connected module nodes connected to the respective shelf node, the second number corresponding to a number of modules on a shelf corresponding to the shelf node; and
for a respective module node: a third number of sequentially connected port nodes connected to the respective module node, the third number corresponding to a number of ports in a module corresponding to the module node.

7. The non-transitory media of claim 6, wherein a last module node of a first shelf node is sequentially connected to a first module node of a second shelf node sequentially connected to the first shelf node; and wherein a last port node of a first module node is sequentially connected to a first port node of a second module node sequentially connected to the first module node.

8. The non-transitory media of claim 1, the operations further comprising:
accessing a third directed acyclic graph representing a second destination patch panel of the one or more destination patch panels, the third directed acyclic graph comprising a plurality of destination port nodes corresponding respectively to the plurality of destination ports in the second destination patch panel; and
traversing the first directed acyclic graph, the second directed acyclic graph, and the third directed acyclic graph in accordance with the selected port assignment strategy to generate a mapping of the plurality of source port nodes to the plurality of destination port nodes.

9. The non-transitory media of claim 8, wherein traversing the first directed acyclic graph, the second directed acyclic graph, and the third directed acyclic graph comprises:
a) traversing the first directed acyclic graph to a first unassigned source port node corresponding to a first unassigned source port;
b) traversing the second directed acyclic graph to a first unassigned destination port node corresponding to a first unassigned destination port;
c) mapping the first unassigned destination port to the first unassigned source port;
d) traversing the first directed acyclic graph from the first source node to a next unassigned source port node;
e) traversing the third directed acyclic graph to a second unassigned destination port node corresponding to a second unassigned destination port;
f) mapping the second unassigned destination port to the next unassigned source port; and
g) repeating steps (a) to (f) until a final node in the first directed acyclic graph is reached.

10. The non-transitory media of claim 8, wherein traversing the first directed acyclic graph, the second directed acyclic graph, and the third directed acyclic graph comprises:
a) traversing the first directed acyclic graph to an unassigned source port node corresponding to an unassigned source port in the first source patch panel;
b) traversing the second directed acyclic graph to an unassigned destination port node corresponding to an unassigned destination port in the first destination patch panel;
c) mapping the unassigned destination port to the unassigned source port;
d) repeating steps (a) to (c) until all of the destination ports in the first destination patch panel are mapped to a source port;
e) traversing the first directed acyclic graph to an unassigned source port node corresponding to an unassigned source port in the first source patch panel;
f) traversing the third directed acyclic graph to an unassigned destination port node corresponding to an unassigned destination port in the second destination patch panel;
g) mapping the unassigned destination port in the second destination patch panel to the unassigned source port; and
h) repeating steps (e) to (g) until a final node in the first directed acyclic graph is reached.

11. The non-transitory media of claim 1, wherein traversing the first directed acyclic graph and the second directed acyclic graph comprises:
a) traversing the first directed acyclic graph to an unassigned source port node corresponding to an unassigned source port in the first source patch panel;
b) traversing the second directed acyclic graph to an unassigned destination port node corresponding to an unassigned destination port in the first destination patch panel;
c) mapping the unassigned destination port to the unassigned source port; and
d) repeating steps (a) to (c) until there are no remaining source ports to map.

12. The non-transitory media of claim 11, the operations further comprising:
accessing a navigation path definition for the first source patch panel; and
traversing the first directed acyclic graph to an unassigned source port node according to the navigation path definition.

13. The non-transitory media of claim 1, wherein traversing the first directed acyclic graph and the second directed acyclic graph comprises:
traversing the first directed acyclic graph to a first plurality of unassigned source port nodes corresponding to a first plurality of unassigned source ports in the first source patch panel;
traversing the second directed acyclic graph to a second plurality of unassigned destination port nodes corresponding to a second plurality of unassigned destination ports in the first destination patch panel; and
mapping the unassigned destination ports in the second plurality of unassigned destination ports to respective individual unassigned source ports in the first plurality of unassigned source ports.

14. The non-transitory media of claim 1, the operations further comprising:
generating a representation of the mapping of the plurality of source port nodes to the plurality of destination port nodes,
wherein the representation comprises a table having a first plurality of cells that correspond to respective ports in the first source patch panel and a second plurality of cells that correspond to respective ports in the first destination patch panel; and
wherein a cell value of a cell corresponding to a particular source port comprises a port identifier for a particular destination port mapped to the particular source port, and a cell value of a cell corresponding to the particular destination port comprises a port identifier for the particular source port mapped to the particular destination port.

15. The non-transitory media of claim 14, the operations further comprising:
selecting a color from a set of unused table cell colors and applying the color to a cell corresponding to the particular source port and to a cell corresponding to the particular destination port.

16. The non-transitory media of claim 1, the operations further comprising:
accessing training data sets, a particular training data set of the training data sets comprising:
a source directed acyclic graph corresponding to a source patch panel;
a destination directed acyclic graph corresponding to a destination patch panel;
a mapping between the source patch panel and the destination patch panel; and
a port assignment strategy applied to generate the mapping;
training a machine learning model based on the training data sets to select a port assignment strategy; and
applying the machine learning model to select the port assignment strategy.

17. The non-transitory media of claim 16, wherein applying the machine learning model comprises applying the machine learning model to the first set of information identifying the plurality of source ports in the one or more source patch panels and to the second set of information identifying the plurality of destination ports in the one or more destination patch panels.

18. A method comprising:
accessing a first set of information identifying a plurality of source ports in one or more source patch panels and a second set of information identifying a plurality of destination ports in one or more destination patch panels;
accessing, based on the first set of information, a first directed acyclic graph representing a first source patch panel of the one or more source patch panels, the first directed acyclic graph comprising a plurality of source port nodes corresponding respectively to the plurality of source ports in the first source patch panel;
accessing, based on the second set of information, a second directed acyclic graph representing a first destination patch panel of the one or more destination patch panels, the second directed acyclic graph comprising a plurality of destination port nodes corresponding respectively to the plurality of destination ports in the first destination patch panel;
selecting a port assignment strategy from a plurality of port assignment strategies for mapping the plurality of source ports to the plurality of destination ports; and
traversing the first directed acyclic graph and the second directed acyclic graph in accordance with the selected port assignment strategy to generate a mapping of the plurality of source port nodes to the plurality of destination port nodes;
wherein the method is performed by at least one device including a hardware processor.

19. The method of claim 18, wherein traversing the first directed acyclic graph and the second directed acyclic graph comprises mapping the plurality of source port nodes to the plurality of destination port nodes based on a) a first order for traversing the plurality of source port nodes using the selected port assignment strategy and b) a second order for traversing the plurality of destination port nodes are traversed using the selected port assignment strategy.

20. The method of claim 18, further comprising generating the first directed acyclic graph based on a navigation path defined for the first source patch panel.

21. The method of claim 18, further comprising:
receiving a source patch panel definition corresponding to the first source patch panel and a destination patch panel definition corresponding to the first destination patch panel;
generating the first directed acyclic graph for the first source patch panel based on the source patch panel definition; and
generating the second directed acyclic graph for the first destination patch panel based on the destination patch panel definition.

22. The method of claim 21, wherein a patch panel definition for a patch panel includes a number of shelves in the patch panel, a number of modules per shelf in the patch panel, and a number of ports per module in the patch panel.

23. The method of claim 18, wherein a directed acyclic graph comprises:
a root node corresponding to a rack;
a first number of sequentially connected shelf nodes connected to the root node, the first number corresponding to a number of shelves in the rack;
for a respective shelf node: a second number of sequentially connected module nodes connected to the respective shelf node, the second number corresponding to a number of modules on a shelf corresponding to the shelf node; and
for a respective module node: a third number of sequentially connected port nodes connected to the respective module node, the third number corresponding to a number of ports in a module corresponding to the module node.

24. The method of claim 23, wherein a last module node of a first shelf node is sequentially connected to a first module node of a second shelf node sequentially connected to the first shelf node; and wherein a last port node of a first module node is sequentially connected to a first port node of a second module node sequentially connected to the first module node.

25. The method of claim 18, further comprising:
accessing a third directed acyclic graph representing a second destination patch panel of the one or more destination patch panels, the third directed acyclic graph comprising a plurality of destination port nodes corresponding respectively to the plurality of destination ports in the second destination patch panel; and
traversing the first directed acyclic graph, the second directed acyclic graph, and the third directed acyclic graph in accordance with the selected port assignment strategy to generate a mapping of the plurality of source port nodes to the plurality of destination port nodes.

26. The method of claim 25, wherein traversing the first directed acyclic graph, the second directed acyclic graph, and the third directed acyclic graph comprises:
h) traversing the first directed acyclic graph to a first unassigned source port node corresponding to a first unassigned source port;
i) traversing the second directed acyclic graph to a first unassigned destination port node corresponding to a first unassigned destination port;
j) mapping the first unassigned destination port to the first unassigned source port;
k) traversing the first directed acyclic graph from the first source node to a next unassigned source port node;
l) traversing the third directed acyclic graph to a second unassigned destination port node corresponding to a second unassigned destination port;
m) mapping the second unassigned destination port to the next unassigned source port; and
n) repeating steps (a) to (f) until a final node in the first directed acyclic graph is reached.

27. The method of claim 25, wherein traversing the first directed acyclic graph, the second directed acyclic graph, and the third directed acyclic graph comprises:
i) traversing the first directed acyclic graph to an unassigned source port node corresponding to an unassigned source port in the first source patch panel;
j) traversing the second directed acyclic graph to an unassigned destination port node corresponding to an unassigned destination port in the first destination patch panel;
k) mapping the unassigned destination port to the unassigned source port;
l) repeating steps (a) to (c) until all of the destination ports in the first destination patch panel are mapped to a source port;
m) traversing the first directed acyclic graph to an unassigned source port node corresponding to an unassigned source port in the first source patch panel;
n) traversing the third directed acyclic graph to an unassigned destination port node corresponding to an unassigned destination port in the second destination patch panel;
o) mapping the unassigned destination port in the second destination patch panel to the unassigned source port; and
p) repeating steps (e) to (g) until a final node in the first directed acyclic graph is reached.

28. The method of claim 18, wherein traversing the first directed acyclic graph and the second directed acyclic graph comprises:
e) traversing the first directed acyclic graph to an unassigned source port node corresponding to an unassigned source port in the first source patch panel;
f) traversing the second directed acyclic graph to an unassigned destination port node corresponding to an unassigned destination port in the first destination patch panel;
g) mapping the unassigned destination port to the unassigned source port; and
h) repeating steps (a) to (c) until there are no remaining source ports to map.

29. The method of claim 28, further comprising:
accessing a navigation path definition for the first source patch panel; and
traversing the first directed acyclic graph to an unassigned source port node according to the navigation path definition.

30. The method of claim 18, wherein traversing the first directed acyclic graph and the second directed acyclic graph comprises:
traversing the first directed acyclic graph to a first plurality of unassigned source port nodes corresponding to a first plurality of unassigned source ports in the first source patch panel;
traversing the second directed acyclic graph to a second plurality of unassigned destination port nodes corresponding to a second plurality of unassigned destination ports in the first destination patch panel; and
mapping the unassigned destination ports in the second plurality of unassigned destination ports to respective individual unassigned source ports in the first plurality of unassigned source ports.

31. The method of claim 18, further comprising:
generating a representation of the mapping of the plurality of source port nodes to the plurality of destination port nodes,
wherein the representation comprises a table having a first plurality of cells that correspond to respective ports in the first source patch panel and a second plurality of cells that correspond to respective ports in the first destination patch panel; and
wherein a cell value of a cell corresponding to a particular source port comprises a port identifier for a particular destination port mapped to the particular source port, and a cell value of a cell corresponding to the particular destination port comprises a port identifier for the particular source port mapped to the particular destination port.

32. The method of claim 31, further comprising:
selecting a color from a set of unused table cell colors and applying the color to a cell corresponding to the particular source port and to a cell corresponding to the particular destination port.

33. The method of claim 18, further comprising:
accessing training data sets, a particular training data set of the training data sets comprising:
a source directed acyclic graph corresponding to a source patch panel;
a destination directed acyclic graph corresponding to a destination patch panel;
a mapping between the source patch panel and the destination patch panel; and
a port assignment strategy applied to generate the mapping;
training a machine learning model based on the training data sets to select a port assignment strategy; and
applying the machine learning model to select the port assignment strategy.

34. The method of claim 33, wherein applying the machine learning model comprises applying the machine learning model to the first set of information identifying the plurality of source ports in the one or more source patch panels and to the second set of information identifying the plurality of destination ports in the one or more destination patch panels.

35. A system comprising:
at least one device including a hardware processor;
the system being configured to perform operations comprising:
accessing a first set of information identifying a plurality of source ports in one or more source patch panels and a second set of information identifying a plurality of destination ports in one or more destination patch panels;
accessing, based on the first set of information, a first directed acyclic graph representing a first source patch panel of the one or more source patch panels, the first directed acyclic graph comprising a plurality of source port nodes corresponding respectively to the plurality of source ports in the first source patch panel;
accessing, based on the second set of information, a second directed acyclic graph representing a first destination patch panel of the one or more destination patch panels, the second directed acyclic graph comprising a plurality of destination port nodes corresponding respectively to the plurality of destination ports in the first destination patch panel;
selecting a port assignment strategy from a plurality of port assignment strategies for mapping the plurality of source ports to the plurality of destination ports; and
traversing the first directed acyclic graph and the second directed acyclic graph in accordance with the selected port assignment strategy to generate a mapping of the plurality of source port nodes to the plurality of destination port nodes.

36. The system of claim 35, wherein traversing the first directed acyclic graph and the second directed acyclic graph comprises mapping the plurality of source port nodes to the plurality of destination port nodes based on a) a first order for traversing the plurality of source port nodes using the selected port assignment strategy and b) a second order for traversing the plurality of destination port nodes are traversed using the selected port assignment strategy.

37. The system of claim 35, the operations further comprising generating the first directed acyclic graph based on a navigation path defined for the first source patch panel.

38. The system of claim 35, the operations further comprising:
receiving a source patch panel definition corresponding to the first source patch panel and a destination patch panel definition corresponding to the first destination patch panel;
generating the first directed acyclic graph for the first source patch panel based on the source patch panel definition; and
generating the second directed acyclic graph for the first destination patch panel based on the destination patch panel definition.

39. The system of claim 38, wherein a patch panel definition for a patch panel includes a number of shelves in the patch panel, a number of modules per shelf in the patch panel, and a number of ports per module in the patch panel.

40. The system of claim 35, wherein a directed acyclic graph comprises:
a root node corresponding to a rack;
a first number of sequentially connected shelf nodes connected to the root node, the first number corresponding to a number of shelves in the rack;
for a respective shelf node: a second number of sequentially connected module nodes connected to the respective shelf node, the second number corresponding to a number of modules on a shelf corresponding to the shelf node; and
for a respective module node: a third number of sequentially connected port nodes connected to the respective module node, the third number corresponding to a number of ports in a module corresponding to the module node.

41. The system of claim 40, wherein a last module node of a first shelf node is sequentially connected to a first module node of a second shelf node sequentially connected to the first shelf node; and wherein a last port node of a first module node is sequentially connected to a first port node of a second module node sequentially connected to the first module node.

42. The system of claim 35, the operations further comprising:
accessing a third directed acyclic graph representing a second destination patch panel of the one or more destination patch panels, the third directed acyclic graph comprising a plurality of destination port nodes corresponding respectively to the plurality of destination ports in the second destination patch panel; and
traversing the first directed acyclic graph, the second directed acyclic graph, and the third directed acyclic graph in accordance with the selected port assignment strategy to generate a mapping of the plurality of source port nodes to the plurality of destination port nodes.

43. The system of claim 42, wherein traversing the first directed acyclic graph, the second directed acyclic graph, and the third directed acyclic graph comprises:
o) traversing the first directed acyclic graph to a first unassigned source port node corresponding to a first unassigned source port;
p) traversing the second directed acyclic graph to a first unassigned destination port node corresponding to a first unassigned destination port;
q) mapping the first unassigned destination port to the first unassigned source port;
r) traversing the first directed acyclic graph from the first source node to a next unassigned source port node;
s) traversing the third directed acyclic graph to a second unassigned destination port node corresponding to a second unassigned destination port;
t) mapping the second unassigned destination port to the next unassigned source port; and
u) repeating steps (a) to (f) until a final node in the first directed acyclic graph is reached.

44. The system of claim 42, wherein traversing the first directed acyclic graph, the second directed acyclic graph, and the third directed acyclic graph comprises:
q) traversing the first directed acyclic graph to an unassigned source port node corresponding to an unassigned source port in the first source patch panel;
r) traversing the second directed acyclic graph to an unassigned destination port node corresponding to an unassigned destination port in the first destination patch panel;
s) mapping the unassigned destination port to the unassigned source port;
t) repeating steps (a) to (c) until all of the destination ports in the first destination patch panel are mapped to a source port;
u) traversing the first directed acyclic graph to an unassigned source port node corresponding to an unassigned source port in the first source patch panel;
v) traversing the third directed acyclic graph to an unassigned destination port node corresponding to an unassigned destination port in the second destination patch panel;
w) mapping the unassigned destination port in the second destination patch panel to the unassigned source port; and
x) repeating steps (e) to (g) until a final node in the first directed acyclic graph is reached.

45. The system of claim 35, wherein traversing the first directed acyclic graph and the second directed acyclic graph comprises:
i) traversing the first directed acyclic graph to an unassigned source port node corresponding to an unassigned source port in the first source patch panel;
j) traversing the second directed acyclic graph to an unassigned destination port node corresponding to an unassigned destination port in the first destination patch panel;
k) mapping the unassigned destination port to the unassigned source port; and
l) repeating steps (a) to (c) until there are no remaining source ports to map.

46. The system of claim 45, the operations further comprising:
accessing a navigation path definition for the first source patch panel; and
traversing the first directed acyclic graph to an unassigned source port node according to the navigation path definition.

47. The system of claim 35, wherein traversing the first directed acyclic graph and the second directed acyclic graph comprises:
traversing the first directed acyclic graph to a first plurality of unassigned source port nodes corresponding to a first plurality of unassigned source ports in the first source patch panel;
traversing the second directed acyclic graph to a second plurality of unassigned destination port nodes corresponding to a second plurality of unassigned destination ports in the first destination patch panel; and
mapping the unassigned destination ports in the second plurality of unassigned destination ports to respective individual unassigned source ports in the first plurality of unassigned source ports.

48. The system of claim 35, the operations further comprising:
generating a representation of the mapping of the plurality of source port nodes to the plurality of destination port nodes,
wherein the representation comprises a table having a first plurality of cells that correspond to respective ports in the first source patch panel and a second plurality of cells that correspond to respective ports in the first destination patch panel; and
wherein a cell value of a cell corresponding to a particular source port comprises a port identifier for a particular destination port mapped to the particular source port, and a cell value of a cell corresponding to the particular destination port comprises a port identifier for the particular source port mapped to the particular destination port.

49. The system of claim 48, the operations further comprising:
selecting a color from a set of unused table cell colors and applying the color to a cell corresponding to the particular source port and to a cell corresponding to the particular destination port.

50. The system of claim 35, the operations further comprising:
accessing training data sets, a particular training data set of the training data sets comprising:
a source directed acyclic graph corresponding to a source patch panel;
a destination directed acyclic graph corresponding to a destination patch panel;
a mapping between the source patch panel and the destination patch panel; and
a port assignment strategy applied to generate the mapping;
training a machine learning model based on the training data sets to select a port assignment strategy; and
applying the machine learning model to select the port assignment strategy.

51. The system of claim 50, wherein applying the machine learning model comprises applying the machine learning model to the first set of information identifying the plurality of source ports in the one or more source patch panels and to the second set of information identifying the plurality of destination ports in the one or more destination patch panels.
